(19) United States
(12) Patent Application Publication
(10) Pub. No.: US 2017/0109903 A1
(43) Pub. Date: Apr. 20, 2017

(54) Method for Reduction of Artifacts and Preservation of Soft Tissue Contrast and Conspicuity of Iodinated Materials on Computed Tomography Images by means of Adaptive Fusion of Input Images Obtained from Dual-Energy CT Scans, and Use of differences in Voxel intensities between high and low-energy images in estimation of artifact magnitude

(71) Applicant: Michal Kulon, East Setauket, NY (US)

(72) Inventor: Michal Kulon, East Setauket, NY (US)

(21) Appl. No.: 14/918,283

(22) Filed: Oct. 20, 2015

(51) Int. Cl. G06T 11/00; G06T 7/00

(52) U.S. Cl. CPC G06T 11/008; G06T 7/0002; G06T 2207/30168; G06T 2207/10081; G06T 2207/10088

(57) ABSTRACT

Image processing method is presented along with reference source code and sample outputs. This method processes 2 (or more) input images which were obtained at different photon energies (or differing in another parameter), and produces an output image that emphasizes the best characteristics of each of the input images, while suppressing the undesired characteristics of each input image. This is different from prior dual-energy CT methods which produce an intermediate compromise image, with an intermediate soft tissue contrast and intermediate artifact suppression, and also different from prior methods that sacrifice soft tissue contrast to maximize artifact reduction.

### Field of the Invention

The invention relates to the fields of image processing, radiology images, in particular an improved image reconstruction method from dual-energy Computed Tomography (CT) images. Same technique can be also be applied to other modalities such as MRI, or photographic images.

### Description of Prior Art

Computerized Tomography (CT) has been extensively used in the fields of radiology, medical diagnosis, industrial quality assurance, and security systems. Conventional CT scanners typically emit a polyenergetic beam consisting of a wide spectrum of differing x-ray photon energies, with the energy spectrum adjustable by the operator of the scanner, typically by setting the acceleration voltage or changing beam filtering materials. Such adjustments may be desired to optimize the resultant image based on considerations such as girth of the imaged structure, presence of metallic implants or other dense material, use of iodinated contrast materials, and patient radiation exposure. Despite the underlying polyenergetic character, conventional CT x-ray spectrum is typically expressed as a single number, e.g. 100 kilo-Volts, describing the acceleration voltage used to produce the x-rays, which usually corresponds to the maximal photon energy (keV) within the spectrum, with the peak of the spectrum typically at approximately 33% of the maximal photon energy. CT scan may be obtained using relatively high energy photons, such as 150 keV, or relatively lower energy photons, such as 80 keV. The use of the terms high- and low- energy implies relative quantities, as the absolute values may be drastically different depending on application, such as in cargo scanning. Conventional CT scanner detector elements were typically unable to distinguish between x-ray photons of differing energies.

Dual-energy CT scanners are now available that produce two image sets simultaneously, resulting in images that are similar to 2 separate acquisitions with a conventional CT scanner, each obtained at a different photon energy.

Methods have also been previously developed that can post-process the acquired dual energy CT data in a manner that produces images which aim to simulate a “monochromatic CT acquisition” at a single energy level, which is adjustable after the scan is acquired (U.S. Pat. No. 7,801,265 B2).

Regardless of acquisition method, typically the low-energy CT images (whether poly- or mono-monochromatic) exhibit relatively good visualization of soft tissues and iodinated contrast, but are markedly degraded by artifacts near metallic or dense objects. High-energy images demonstrate the inverse characteristics of relatively poor visualization of soft tissue and iodinated material, but good suppression of metallic and beam hardening artifacts (see example input images in FIG. 2).

Previously published methods of artifact reduction often entail raising the photon energy of a conventional CT scanner, or using or displaying the higher energy scan from dual- energy acquisitions, or displaying a relatively high-energy virtual mono-energetic reconstruction from a dual-energy scan. Although raising photon energy leads to reduction metallic and beam hardening artifacts, such methods inversely result in degradation of soft tissue contrast and reduction in conspicuity of iodinated contrast agents.

Prior U.S. Pat. No. 7,801,265 B2 describes a method for using weighting factors that are constant for the entire low-energy image and constant for high-energy image to produce an image that simulates an image obtained at a single energy of an intermediate value. Using such intermediate image may produce a reasonable compromise trade-off between artifacts vs. soft tissue visualization, but such a resultant intermediate image neither excels in artifact suppression nor soft tissue contrast and iodinated contrast material conspicuity.

### SUMMARY OF THE INVENTION

Priority is claimed based on Provisional Patent Application filed on Apr. 27, 2015, Application Number 62/152,974.

The present invention represents an improvement over approaches recited in U.S. Pat. No. 7,801,265, by using voxel-by-voxel weighting factors that vary over the image region, and these weighting factors are determined individually on a voxel-by-voxel basis, as opposed to being constant for the entire input image. Also presented is a new method for calculating such weighting factors in a manner that reduces artifacts of multiple varieties, such as metallic streak, beam hardening, and photon starvation artifacts, while preserving contrast and good visualization of iodinated contrast materials. Unlike an image resulting from method in U.S. Pat. No. 7,801,265 B2, an image produced by the present new method is not a single-energy image, but instead is an image where different voxels mimic having been acquired at different energies, with a possibility that some of the output voxels are purely representative of the corresponding voxel on the low-energy image, some voxels purely representative of the corresponding voxel on the high-energy image, and some output voxels being a variable blend between the input voxels.

The fused images produced by the current invention demonstrate best features of the high energy and low energy images rather than a compromise between desirable and undesirable characteristics.

The presented method typically processes 2 CT image sets which were obtained or reconstructed at different photon energies, and produces an output image, which aims to reduce said artifacts, and aims to maximally preserve the soft tissue contrast and conspicuity of iodinated materials on computed tomography images.

Each output voxel intensity (V) is a weighted average of the 2 corresponding voxels from the low-energy (e.g. 70-keV) and high-energy (e.g. 130-keV) mono-energetic images, although poly-energetic images or different energy level values may also be used:

V_{output, x, y, z}=w_{x, y, z}·V_{LowEnergy, x, y, z}+(1-w_{x, y, z})·V_{HighEnergy, x, y, z}

The weighting factor (w, range 0 to 1) is calculated separately for each output voxel, and favors the low-energy input voxel due to the generally better soft tissue contrast on low energy images, unless the voxel is likely to be degraded by artifact, in which case the high-energy input voxel is favored. The likelihood and magnitude of artifact are considered to be higher (leading to decrease in w) if:

Attenuation value is significantly lower within the lower energy voxel (such as 70 keV) than within higher energy voxel (such as 130 keV), implying an area of dark photon-starvation streak artifact. In the example embodiment, a gradual transition is made, with the voxel-by-voxel weighting factor of 0.5 at 40 Hounsfield Units.

The voxel is closer to other voxels containing metal or other very dense material (such as >1100 Hounsfield Units). The magnitude of this proximity effect is estimated by calculating a quantity termed here Metal Effect, which is akin to a gravitational field arising from dense materials. Similar to gravity, this quantity decreases as 1/distance-squared in the example implementation, but other mathematical functions could be used to approximate this or optimize the implementation for a specific application (such as a Gaussian distribution, 1/R, etc). Alternatively, blurring a thresholded image may provide a fast approximation to 1/distance-squared in some embodiments, such as embodiments intended to utilize Graphical Processing Units.

In order to avoid sharp transitions between neighboring output pixels, which could theoretically produce undesired artifactual edges, a sigmoid curve or similar may used to limit the value of weighting factor (w) between 0 and 1, and to ensure smooth transitions throughout the range of w (0 and 1).

### BRIEF DESCRIPTION OF THE DRAWINGS

FIG. 1: schematic diagram illustrating the problem of inverse strengths and weaknesses of higher- and lower- energy CT images, and the overall method of fusing these in a manner that retains the best qualities of both images, while diminishing their weaknesses.

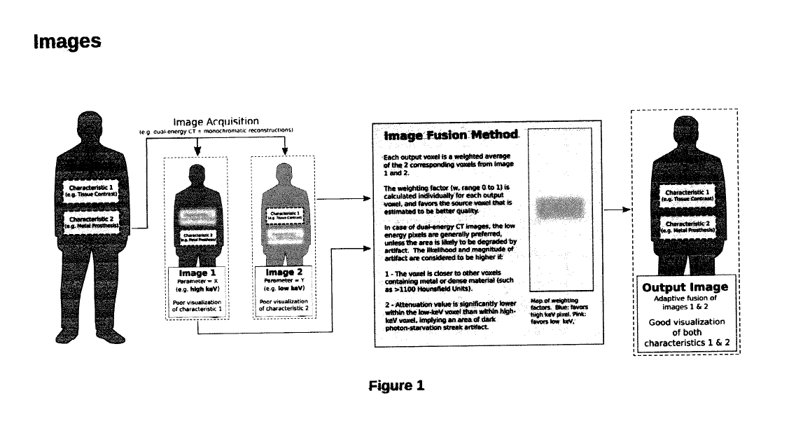

FIG. 2: example input and output images produced by an embodiment of this method illustrate good artifact reduction and good soft tissue contrast of the output images.

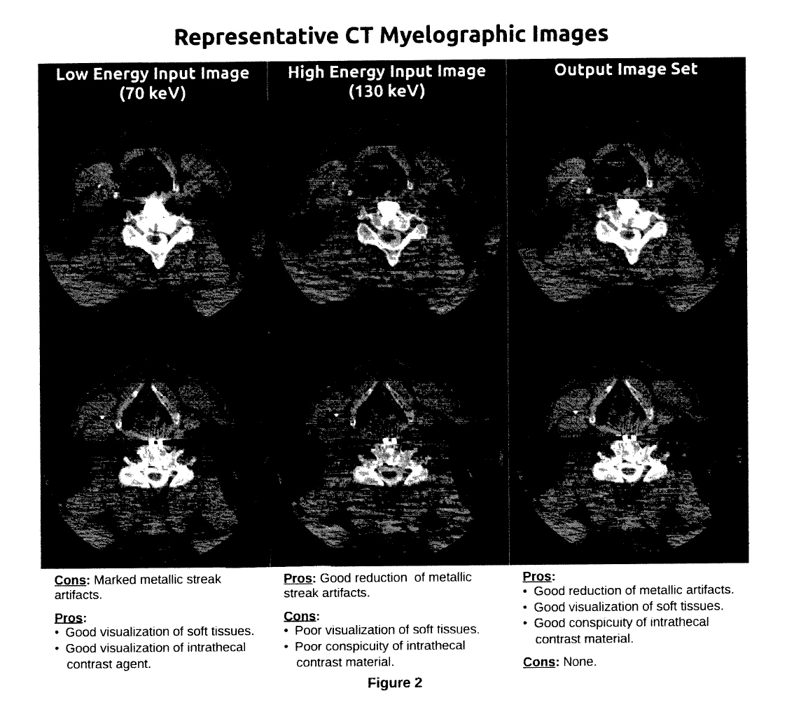

FIG. 3: interim map of calculated weighting factors corresponding to the reference images, as produced by the provided reference software implementation. Black areas correspond to weighting factor (w) being close to 0 and thus favoring the pixels from high-energy image. White areas correspond to weighting factor (w) being close to 1 and favoring the low-energy pixels.

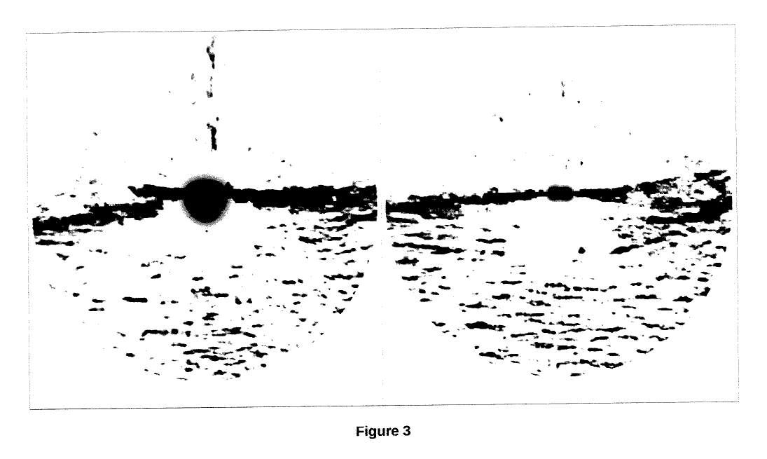

### DETAILED DESCRIPTION OF THE PREFERRED EMBODIMENTS

Included C++ code excerpts from an example embodiment are intended to convey the underlying methods to those skilled in the art. Although the reference code processes dual-energy CT images, essentially the same method, or some of the provided computer code, can be used to process images obtained via other modalities, such as MRI, to optimize other characteristics, such as reduction of motion artifact (as opposed to streak artifact), or increase conspicuity of pathologic processes or normal structures. Third image (or more) can be optionally incorporated into this method by including additional terms in the voxel-by-voxel weighted average described above. Such a third image can also be used as a determinant of weight (w) itself (similar or substituted for the aforementioned Metal Effect image, which is calculated rather than acquired in the example embodiment). A voxel-by-voxel parameter similar to (w) above, can also be used to represent a target monochromatic energy level rather than a weighting factor, leading to different pixels being reconstructed at differing monochromatic energies within the same image, based on likelihood of artifact or other characteristic affecting the pixel.

Example embodiments of this method include, but are not limited to, software instructions intended to be executed on CPU(s) or Graphical Processing Units (GPU), or implementations in any of the available computer programming languages, or electronic circuit, or Field Programmable gate array, integrated circuit, clustered computing nodes, and any combinations thereof. Embodiments implementing this method can be integrated into other systems, such as Radiology Picture Archiving and Communication Systems (PACS), separate processing work-stations, integrated into a CT scanner, or implemented into a stand-alone DICOM node (Digital Imaging and Communications in Medicine Standard), which accepts images from the network and re-transmits the results to PACS or other storage/display system.

Another mathematical function may be substituted for the sigmoid function, as well as approximations thereof. Substituting simple clamping and thresholding, or use of pre-calculated lookup tables may be helpful in some embodiments of this method on CPUs or processing elements that that have limited processing power, where evaluation of the sigmoid function may be too time-consuming.

Excerpts of a reference C++ implementation are provided below. Names of the presented functions or variables can be changed:

```
/*
- Implementing application should load or acquire the high- and low- energy images.
- Implementing application should pre-calculate temporary image “Metal Effect” such as by calling the
function getMetalEffectImage(...) below, unless this is not needed due to ability to calculate this
efficiently when needed, or availability of a third input image which measures or calculates this
directly. Since function getMetalEffectImage(..) is relatively time-consuming, other mathematical
functions can be substituted to estimate the amount of metallic effect, such as blurring a thresholded
image, 1/distance, and others.
- For each pixel / voxel at x,y, z position, invoke the function blend(...) and store its return value
into the voxel in the output image at corresponding position x,y,z.
*/
/*------------------------------------------------------------*/
inline double sigmoid(double x, double centerX, double k){
    /* clamps input x to range between 0 and 1, with smooth transitions near 0 and 1
        centerX: sigmoid curve will be centered at centerX, where output will be 0.5
        k: adjusts the slope of the curve
    */
    return 1.0 / ( 1 + exp( k*(x−centerX)) );
}
/*------------------------------------------------------------*/
inline double blend(double pixelLowKEV, double pixelHighKEV, float metalEffect, double *weight){
    /*
        pixelLowKEV, pixelHighKEV: input pixel values in Hounsfield Units or other units.
        metalEffect: pixel value of the interim, calculated image estimating the magnitude and
                likelihood of metallic artifact based on proximity to metal.
        weight: used here as one of the outputs, to enable display of the weighting factors.
                Implementations may omit this output.
        RETURN: the output pixel value of fused image.
    */
    double t;
    double dh;
    dh = pixelHighKEV − pixelLowKEV; /* difference in Hounsfield Units. Ratio can also be used, or
                        other units */
    if(metalEffect<300){
        *weight = 1 − (metalEffect / 300.0 );
        if(dh > 0){
            /*
                Adjustable parameters centerX and k.
                At dh=40 Hounsfield Units, t will be 0.5
                In other words, equal contribution from low- and -high energy images
                    when low-energy pixel is darker by 40 HU
            */
            t = sigmoid(dh, 40, 0.2);
```

| | |
|---|---|
| *weight = min( *weight, t); /* | average or other combination |
| | can be substituted for min */ |

```
        }// else pixelLowKEV is brighter -- use low-Energy pixel, or w based on metalEffect
    }else{
        //metalEffect = 300;
        *weight = 0;
        return pixelHighKEV;
    }
    /* Output pixel = Weighted average of the corresponding pixels in low & high keV images. */
    return ( (*weight) * pixelLowKEV + (1.0 − *weight) * pixelHighKEV );
}
/*------------------------------------------------------------*/
template<typename T>
float* getMetalEffectImage(T* pixelDataHigh, int w, int h, pixelConversionT<T> pc, double
pixelLengthCM, double k){
/*
pixelDataHigh: Matrix or image containing the voxels. High-energy pixels were used because of the
observed reduced high-intensity streak artifacts, but low-energy pixels or average of high and low
pixels can be substituted here if needed. T is adjustable, and may represent pixel format that may be
dependent on application (such as DICOM)
w: image width
h: image height
pixelConversionT<T> pc: object or function that can convert between internal memory pixel
representation (typically integer in DICOM) to Hounsfield Units.
PixelLengthCM: physical dimension of pixel in centimeters. If pixels are not square, another parameter
can be added for each of the dimension.
k: Adjustable intensity of the metalEffect field.
*/
```

| | |
|---|---|
| int | x,y,i; |
| int | x2,y2, i2; |
| int | dx,dy, dy2; |
| long | nMetal; |
| double | v, dist2, alpha; |
| float | *a; |
| bool | *b; |

```
    a = new float[w*h]; //allocate an image which will hold the magnitudes of metallic effect
    //Zero out image “a”
    for(i=w*h−1; i>=0; i−−){
        a[i] = 0;
    }
    alpha = pixelLengthCM * pixelLengthCM;
    nMetal = 0;
    //iterate over source image to detect metal
    for(y=0, i=0; y<h;y++){
        for(x=0; x<w; x++, i++){
            v = pc.convert(pixelDataHigh[i]); //convert integer representation to HU
            if(v>metalThreshold){ /*adjustable threshold for categorizing the voxel
                        as “metallic/dense”, such as 1100 HU*/
                nMetal++;
                /*Calculate the effect of metallic pixel at x,y on all other pixels
                Alternatively, thresholded image can be blurred, which may be
                faster on some platforms*/
                for(y2=0, i2=0; y2<h; y2++){
                    dy = (y2−y); //delta−y
                    dy2 = dy*dy; //delta−y squared
                    for (x2=0; x2<w; x2++, i2++){
                        if((y2==y) && (x2==x) ){
                            continue; //skip: same pixel
                        }
                        dx = (x2−x);
                        dist2 = alpha * (dx*dx + dy2); //distance-squared
                        a[i2] += k/dist2 ; /* Gravity-like field.
                                    Gaussian, 1/R or
                                    other functions may be used*/
                    }
                }
            }
        }
    }
    return a; //return the Metal Effect image for subsequent use
}
/*------------------------------------------------------------*/
/* Helper Object that may be helpful to facilitate conversion between DICOM representation and
    Hounsfield Units
*/
template<typename T>
class pixelConversionT{
    public:
        double dmin;
        double dmax;
        double slope;
        double slopeU;
        double intercept;
        double interceptU;
        double drange;
```

| | |
|---|---|
| double | uwater; |
| T | imin; |
| T | imax; |

```
        void init(double auwater){
            drange = dmax − dmin;
            slope = (drange) / (imax−(double)imin);
            intercept = drain − slope*imin;
            uwater = auwater;
            slopeU = slope * (uwater/1000.0);
            interceptU = intercept * (uwater/1000.0) + uwater;
        }
```

| | |
|---|---|
| inline | double convert(T pix){ |

```
            return pix * slope + intercept;
        }
inline double getU(T pix){
    return pix * slopeU + interceptU;
}
```

These above descriptions are only intended to illustrate some of the possible embodiments of the present invention rather than limiting the scope of such embodiments. For those skilled in the art, any change or substitution that can be made readily within the scope of the present invention should be encompassed by its scope. The scope of the invention should be defined by the claims.

1. An image processing method for reduction of undesired image characteristics and preservation of desired characteristics based on at least 2 input image sets, wherein the image sets portray essentially a same object, and wherein the said images contain elements such as pixels, voxels or matrix elements, by means of analyzing the differing image sets on a voxel-by-voxel basis, or groups of voxels, using a combination of one or more metrics that estimate the quality of each voxel.

2. Claim 1, wherein the input image sets cue obtained, stored, transmitted, or reprocessed from a Computed Tomography scanner, with at least one these image sets having a differing parameter from other image sets, with the said parameter selected from a set of parameters comprising a photon energy level, voltage used to generate the scan, or post-processing parameter.

3. Claims 1, wherein the input image sets are analyzed and calculations are performed by means of any computing device selected from a set comprising CPU (central processing unit), GPU (graphics processing unit), FPGA (field-programmable gate array), integrated circuit, electronic circuit, according to a set of instructions encoded on a computer-readable medium, or encoded as elements of an electronic circuit.

4. Claim 1, wherein the said metric recited in claim 1 is based on one or more mathematical calculations from a set comprising a difference in voxel element values, ratio of voxel element values, boolean comparison between voxel values, approximation of truncated infinite series evaluation of voxel values.

5. Claim 1, wherein the said metric is based on voxels proximity to one or more structures that are likely to be associated with artifacts.

6. Claim 5, wherein the said structures are automatically detected by comparing the value of a voxel to an element from a set of elements comprising: threshold value, range of values.

7. Claim 6, wherein the said threshold value is equivalent to the broad vicinity 1000 Hounsfield Units, typically ranging from 300 to 5000 Hounsfield units.

8. Claim 5, wherein the magnitude of an effect caused by proximity to dense structures approximates a mathematical function from a set of mathematical functions comprising constant divided by distance-squared, constant divided by distance, Gaussian distribution, distribution resembling a gravitational field.

9. Claim 1, wherein the said metric for estimation of voxel quality is based on the reverse concept of estimating undesirable voxel characteristic by a means of estimation of the magnitude or likelihood or a combination of magnitude with likelihood of an undesirable characteristic.

10. Claim 4, wherein the value of one or more voxels from lower energy image is subtracted from the corresponding one or more voxels on the higher energy image to compute the likelihood or magnitude or combination of likelihood and magnitude of undesirable characteristic.

11. Claim 10, wherein the said undesirable characteristic is at least one characteristic from a set of characteristics comprising artifact, streak artifact, photon starvation artifact, beam hardening artifact, motion artifact, windmill artifact, quantum mottle noise.

12. Claim 1, wherein a voxel-by-voxel weighted average is used to combine individual voxels from the corresponding locations within the sets of differing input images, with the voxel-by-voxel weighting factor calculated or measured for a small group of voxels, inclusive of a group comprising a single voxel.

13. Claim 12, wherein the range of a weighting factor is limited to 0 to 1.

14. Claim 12, wherein a means of calculation of an exact or approximated sigmoid function is used to reduce the possibility of abrupt artifactual transitions.

15. Claim 1, wherein the image sets are obtained from a Magnetic Resonance Scanner.

16. Claim 1, wherein the image sets are radiographs.
